(19) United States
(12) Patent Application Publication
(10) Pub. No.: US 2024/0320668 A1
(43) Pub. Date: Sep. 26, 2024

(54) TRANSACTION PROCESSING METHOD AND APPARATUS, AND DEVICE AND STORAGE MEDIUM

(71) Applicant: CHINA UNIONPAY CO., LTD., Shanghai (CN)

(72) Inventor: Yuzhuang XU, Shanghai (CN)

(21) Appl. No.: 18/579,235

(22) PCT Filed: Feb. 18, 2022
(86) PCT No.: PCT/CN2022/076930

§ 371 Date: Jan. 12, 2024

(30) Foreign Application Priority Data
Aug. 27, 2021 (CN) 202110994332.6

(51) Int. Cl. G06Q 20/38

(52) U.S. Cl. CPC G06Q 20/389

(57) ABSTRACT

A transaction processing method includes, when receiving a transaction request sent by a blockchain, sending a corresponding transaction pre-processing request to an off-chain payment system, so that the off-chain payment system performs a corresponding transaction pre-processing operation, to obtain a transaction pre-processing outcome; receiving the transaction pre-processing outcome sent by the off-chain payment system, and sending the transaction pre-processing outcome to the blockchain; and when it is detected that the blockchain has generated an on-chain transaction outcome corresponding to the transaction request, sending a transaction instruction note to the off-chain payment system, where the transaction instruction note is used to instruct the off-chain payment system to perform a corresponding off-chain processing operation to obtain an off-chain transaction outcome corresponding to the transaction request. The on-chain transaction outcome is obtained by the blockchain that performs an on-chain processing operation corresponding to the transaction request based on the transaction pre-processing outcome.

### CROSS-REFERENCE TO RELATED APPLICATION

The disclosure claims priority to Chinese Patent Application No. 202110994332.6, filed on Aug. 27, 2021, and entitled “TRANSACTION PROCESSING METHOD AND APPARATUS, AND DEVICE AND STORAGE MEDIUM,” the entire content of which is incorporated herein by reference.

### TECHNICAL FIELD

The present disclosure relates to the field of blockchain technology and, more particularly, to a transaction processing method, apparatus, device, and storage medium.

### BACKGROUND

Blockchain is a novel application mode of computer technology that includes distributed data storage, peer-to-peer transmission, consensus mechanisms, encryption algorithms, and so on. Blockchain, essentially a decentralized database, is a series of data blocks associated through cryptographic methods. Each data block contains information about a batch of network transactions used to verify the validity (anti-counterfeiting) of the information and generate a next block.

From the perspective of technical classification, blockchain is divided into the public chain, alliance chain, and private chain. The current blockchain is dominated by alliance chains. For alliance chains, due to domestic regulatory policy restrictions, alliance chains generally do not have an incentive mechanism and basically have no token. Therefore, the blockchain cannot handle payment transactions.

### SUMMARY

Embodiments of the disclosure provide a transaction processing method, apparatus, device, and storage medium that are configured to process transactions through the blockchain, which improves transaction credibility and security.

In one aspect, embodiments of the disclosure provide a transaction processing method, and the method includes: when receiving a transaction request sent by a blockchain, sending a corresponding transaction pre-processing request to an off-chain payment system, so that the off-chain payment system performs a corresponding transaction pre-processing operation, to obtain a transaction pre-processing outcome; receiving the transaction pre-processing outcome sent by the off-chain payment system, and sending the transaction pre-processing outcome to the blockchain; and when it is detected that the blockchain has generated an on-chain transaction outcome corresponding to the transaction request, sending a transaction instruction note to the off-chain payment system, where the transaction instruction note is used to instruct the off-chain payment system to perform a corresponding off-chain processing operation to obtain an off-chain transaction outcome corresponding to the transaction request, where the on-chain transaction outcome is obtained by the blockchain that performs an on-chain processing operation corresponding to the transaction request based on the transaction pre-processing outcome.

In another aspect, embodiments of the disclosure provide another transaction processing method, and the method includes: receiving a transaction pre-processing request sent by a payment front-end device and performing a corresponding transaction pre-processing operation, to obtain a transaction pre-processing outcome, where the transaction pre-processing request is sent by the payment front-end device to an off-chain payment system after receiving a transaction request sent by a blockchain; sending the transaction pre-processing outcome to the payment front-end device to allow the payment front-end device to send the transaction pre-processing outcome to the blockchain; and receiving a transaction instruction note sent by the payment front-end device and performing a corresponding off-chain processing operation to obtain an off-chain transaction outcome corresponding to the transaction request, where the transaction instruction note is sent by the payment front-end device to the off-chain payment system when it is detected that the blockchain has generated an on-chain transaction outcome corresponding to the transaction request, where the on-chain transaction outcome is obtained by the blockchain that performs an on-chain processing operation corresponding to the transaction request based on the transaction pre-processing outcome.

In another aspect, embodiments of the disclosure provide a transaction processing device, and the device includes: a first receiving module, configured to send a corresponding transaction pre-processing request to an off-chain payment system when receiving a transaction request sent by a blockchain, so that the off-chain payment system performs a corresponding transaction pre-processing operation, to obtain a transaction pre-processing outcome; a first transmitting module, configured to receive the transaction pre-processing outcome sent by the off-chain payment system, and send the transaction pre-processing outcome to the blockchain; and a first processing module, configured to send a transaction instruction note to the off-chain payment system when it is detected that the blockchain has generated an on-chain transaction outcome corresponding to the transaction request, where the transaction instruction note is used to instruct the off-chain payment system to perform a corresponding off-chain processing operation to obtain an off-chain transaction outcome corresponding to the transaction request, where the on-chain transaction outcome is obtained by the blockchain that performs an on-chain processing operation corresponding to the transaction request based on the transaction pre-processing outcome.

Optionally, the transaction request is sent by the blockchain by calling an oracle on a payment front-end device through a smart contract.

Optionally, the first receiving module is specifically configured for: receiving an encrypted transaction request sent by the blockchain, where the transaction request is encrypted by the blockchain based on a public key of a payment front-end device; decrypting the encrypted transaction request to obtain transaction information in the transaction request; and generating the transaction pre-processing request based on the transaction information, and sending the transaction pre-processing request to the off-chain payment system.

Optionally, the first receiving module is specifically configured for: when receiving a transaction request sent by the blockchain, determining whether the on-chain transaction identifier, contract name, and call sequence number included in the transaction request are consistent with an on-chain transaction identifier, contract name, and call sequence number included in a historical transaction request; and if the on-chain transaction identifier, contract name, and call sequence number included in the transaction request are consistent with an on-chain transaction identifier, contract name, and call sequence number included in a historical transaction request, sending the corresponding transaction pre-processing request to the off-chain payment system.

Optionally, the first receiving module is further configured for: if the on-chain transaction identifier, contract name, and call sequence number included in the transaction request are consistent with an on-chain transaction identifier, contract name, and call sequence number included in a historical transaction request, determining whether a transaction pre-processing outcome corresponding to the transaction request has been cached; if the transaction pre-processing outcome corresponding to the transaction request has been cached, sending the cached transaction pre-processing outcome corresponding to the transaction request to the blockchain; and if the transaction pre-processing outcome corresponding to the transaction request has not been cached, waiting for the off-chain payment system to return the transaction pre-processing outcome corresponding to the transaction request.

Optionally, the first processing module is further configured for: when it is detected that the blockchain has generated a predefined number of blocks corresponding to the transaction request, determining that the on-chain transaction outcome corresponding to the transaction request indicates a successful on-chain transaction; and if it is not detected that the blockchain has generated a predefined number of blocks corresponding to the transaction request, determining that the on-chain transaction outcome corresponding to the transaction request indicates an unsuccessful on-chain transaction, where the predefined number is determined based on configuration information of a consensus algorithm or endorsement strategy in the blockchain.

Optionally, the transaction request includes at least a sender account and a payment amount, and the transaction pre-processing request includes a request to lock the payment amount in the sender account; and the first processing module is specifically configured for: when it is detected that the on-chain transaction outcome indicates a successful on-chain transaction, sending a first transaction instruction note to the off-chain payment system, where the first transaction instruction note is used to instruct the off-chain payment system to control the sender account to transfer the payment amount to a recipient account in the transaction request, to obtain a first off-chain transaction outcome.

Optionally, the first processing module is further configured for: when it is detected that the on-chain transaction outcome indicates an unsuccessful on-chain transaction, sending a second transaction instruction to the off-chain payment system, where the second transaction instruction note is used to instruct the off-chain payment system to release the payment amount in the sender account, to obtain a second off-chain transaction outcome.

Optionally, the transaction request includes at least a sender account, a payment amount, and a recipient account, and the transaction pre-processing request includes controlling the sender account to transfer the payment amount to the recipient account and locking the payment amount in the recipient account; and the first processing module is specifically configured for: when it is detected that the on-chain transaction outcome indicates a successful on-chain transaction, sending a third transaction instruction note to the off-chain payment system, where the third transaction instruction note is used to instruct the off-chain payment system to release the payment amount in the recipient account, to obtain a third off-chain transaction outcome.

Optionally, the first processing module is further configured for: when it is detected that the on-chain transaction outcome indicates an unsuccessful on-chain transaction, sending a fourth transaction instruction note to the off-chain payment system, where the fourth transaction instruction note is used to instruct the off-chain payment system to control the recipient account to return the payment amount to the sender account, to obtain a fourth off-chain transaction outcome.

Optionally, the sender account is a payment token applied by a client terminal from a token service provider through a payment front-end device.

Optionally, the transaction request includes a sender address, a digital currency string corresponding to the sender address, and a recipient address, where the sender address and the recipient address are obtained by a client terminal through a digital currency wallet, and the transaction pre-processing request includes a request to lock the digital currency string; and the first processing module is specifically configured for: when it is detected that the on-chain transaction outcome indicates a successful on-chain transaction, sending a fifth transaction instruction note to the off-chain payment system, where the fifth transaction instruction note is used to instruct the off-chain payment system to control a transfer of the digital currency string from the sender address to the recipient address, to obtain a fifth off-chain transaction outcome.

Optionally, the first processing module is further configured for: when it is detected that the on-chain transaction outcome indicates an unsuccessful on-chain transaction, sending a sixth transaction instruction note to the off-chain payment system, where the sixth transaction instruction note is used to instruct the off-chain payment system to release the digital currency string, to obtain a sixth off-chain transaction outcome.

In another aspect, embodiments of the disclosure provide another transaction processing device, and the device includes: a second receiving module, configured to receive a transaction pre-processing request sent by a payment front-end device and perform a corresponding transaction pre-processing operation, to obtain a transaction pre-processing outcome, where the transaction pre-processing request is sent by the payment front-end device to an off-chain payment system after receiving a transaction request sent by a blockchain; a second transmitting module, configured to send the transaction pre-processing outcome to the payment front-end device to allow the payment front-end device to send the transaction pre-processing outcome to the blockchain; and a second processing module, configured to receive a transaction instruction note sent by the payment front-end device and perform a corresponding off-chain processing operation to obtain an off-chain transaction outcome corresponding to the transaction request, where the transaction instruction note is sent by the payment front-end device to the off-chain payment system when it is detected that the blockchain has generated an on-chain transaction outcome corresponding to the transaction request, where the on-chain transaction outcome is obtained by the blockchain that performs an on-chain processing operation corresponding to the transaction request based on the transaction pre-processing outcome.

Optionally, the transaction request includes at least a sender account and a payment amount, and the transaction pre-processing request includes a request to lock the payment amount in the sender account; and the second receiving module is specifically configured for: receiving the transaction pre-processing request sent by the payment front-end device and locking the payment amount in the sender account.

Optionally, the second processing module is specifically configured for: receiving a first transaction instruction note sent by the payment front-end device, and controlling the sender account to transfer the payment amount to a recipient account in the transaction request, to obtain a first off-chain transaction outcome; or receiving a second transaction instruction note sent by the payment front-end device, and releasing the payment amount in the sender account, to obtain a second off-chain transaction outcome.

Optionally, the transaction request includes at least a sender account, a payment amount, and a recipient account, and the transaction pre-processing request includes controlling the sender account to transfer the payment amount money to the recipient account and locking the payment amount in the recipient account; and the second receiving module is specifically configured for: receiving the transaction pre-processing request sent by the payment front-end device, controlling the sender account to transfer the payment amount to the recipient account and locking the payment amount in the recipient account.

Optionally, the second processing module is specifically configured for: receiving a third transaction instruction note sent by the payment front-end device, and releasing the payment amount in the recipient account, to obtain a third off-chain transaction outcome; or receiving a fourth transaction instruction note sent by the payment front-end device, controlling the recipient account to return the payment amount to the sender account, to obtain a fourth off-chain transaction outcome.

Optionally, the transaction request includes a sender address, a digital currency string corresponding to the sender address, and a recipient address, where the sender address and the recipient address are obtained by a client terminal through a digital currency wallet, and the transaction pre-processing request includes a request to lock the digital currency string; and the second receiving module is specifically configured for: receiving the transaction pre-processing request sent by the payment front-end device and locking the digital currency string.

Optionally, the second processing module is specifically configured for: receiving a fifth transaction instruction note sent by the payment front-end device, and controlling a transfer of the digital currency string from the sender address to the recipient address, to obtain a fifth off-chain transaction outcome; or receiving a sixth transaction instruction note sent by the payment front-end device, releasing the digital currency string, to obtain a sixth off-chain transaction outcome.

In another aspect, embodiments of the disclosure provide a computer device, which includes a memory, a processor, and a computer program stored in the memory and executable on the processor, where the processor, when executing the program, implements the steps of the methods described above.

In another aspect, embodiments of the disclosure provide a computer-readable storage medium, which stores a computer program executable on a computer device, where the computer program, when executed on the computer device, causes the computer device to implement the steps of the methods described above.

In another aspect, embodiments of the disclosure provide a computer program product, which includes a computer program stored on a computer-readable storage medium, the computer program including program instructions that, when executed by a computer device, cause the computer device to implement the steps of the methods described above.

In the embodiments of the disclosure, when the payment front-end device receives a transaction request sent by the blockchain, the payment front-end device sends a corresponding transaction pre-processing request to the off-chain payment system. The off-chain payment system performs a corresponding transaction pre-processing operation, to obtain a transaction pre-processing outcome. The sender account or recipient account in the transaction request is one of many types of offline payment accounts. Therefore, the payment transaction method in the disclosure is adapted to many types of off-chain payment systems, to meet the usage of different types of payment accounts, which enhances the versatility of the payment transaction methods provided in the disclosure.

The payment front-end device receives the transaction pre-processing outcome sent by the off-chain payment system and sends the transaction pre-processing outcome to the blockchain. When it is detected that the blockchain has generated an on-chain transaction outcome corresponding to the transaction request, a transaction instruction note is sent to the off-chain payment system. The transaction instruction note is used to instruct the off-chain payment system to perform a corresponding off-chain processing operation to obtain an off-chain transaction outcome corresponding to the transaction request. The on-chain transaction outcome is obtained by the blockchain that performs an on-chain processing operation for the transaction request based on the transaction pre-processing outcome. The transaction processing method provided by the disclosure realizes the payment transaction within an alliance chain. The payment transaction is processed based on both the on-chain transaction and the off-chain transaction. That is, based on the transaction pre-processing outcome of the off-chain transaction, the blockchain performs the on-chain transaction for the transaction request to obtain the on-chain transaction outcome. The off-chain payment system then performs the off-chain transaction for the transaction request based on the on-chain transaction outcome to obtain the off-chain transaction outcome. The on-chain transaction may initiate a transaction request through a smart contract, thereby ensuring that the on-chain transaction is performed in a trusted environment. Since the on-chain transaction and off-chain transaction are performed interactively, the credibility and security of the off-chain transaction are also guaranteed, and erroneous transactions caused by human errors that exist when only the off-chain transaction is performed may be avoided.

### BRIEF DESCRIPTION OF THE DRAWINGS

To provide a clearer explanation of the technical solutions in the embodiments of the present disclosure, a brief introduction to the drawings in conjunction with the description of the embodiments will be given below. It is evident that the drawings in the following description are merely some embodiments of the present disclosure. Those skilled in the art may obtain additional drawings based on these drawings without exercising inventive efforts.

FIG. 1 illustrates a schematic diagram of a system architecture, according to embodiments of the disclosure;

FIG. 2 is a flowchart of a transaction processing method, according to embodiments of the disclosure;

FIG. 3 is a flowchart of another transaction processing method, according to embodiments of the disclosure;

FIG. 4 is a flowchart of another transaction processing method, according to embodiments of the disclosure;

FIG. 5 is a flowchart of another transaction processing method, according to embodiments of the disclosure;

FIG. 6 is a flowchart of another transaction processing method, according to embodiments of the disclosure;

FIG. 7 illustrates a schematic structural diagram of a transaction processing device, according to embodiments of the disclosure;

FIG. 8 illustrates a schematic structural diagram of another transaction processing device, according to embodiments of the disclosure;

FIG. 9 illustrates a schematic structural diagram of a computer device, according to embodiments of the disclosure.

### DETAILED DESCRIPTION OF THE EMBODIMENTS

To make the purposes, technical solutions, and beneficial effects of the present disclosure clearer, the following detailed description is provided in conjunction with the drawings and specific embodiments. It should be understood that the specific embodiments described here are merely for explaining the disclosure and are not intended to limit the disclosure.

For ease of understanding, the following explanations are provided for certain terms used in the embodiments of the present disclosure.

Alliance Chain: A cluster including multiple private chains, and a blockchain managed by multiple parties. Each organization or party manages one or more nodes, and its data is only allowed to be read, written, and sent by different parties within the system.

Smart Contract: A contract on a computer system that may be automatically executed when certain conditions are met.

Oracle: A device that connects external data and smart contracts, acts as an intermediate layer between a blockchain and data application programming interfaces (APIs), and converts data into a format that may be read by the blockchain.

Token Request (TR): A payment token requester, which is a party that submits a token application to a token service provider.

Token Service Provider (TSP): A token service provider, which is responsible for generating and maintaining tokens. It is also responsible for managing payment token requesters and providing them with token-related services.

Token: Payment token, which refers to a substitute value of a primary account number (PAN), and generally includes 13 to 19 digits. This substitute value must comply with the basic verification rules of the primary account, including LUHN algorithm verification.

Asymmetric Encryption: A cryptosystem that uses a pair of keys (public and private keys) for encryption.

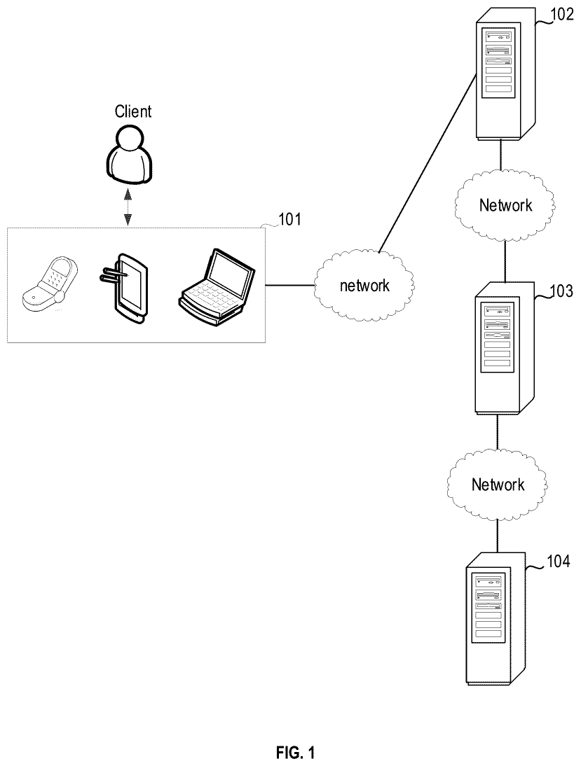

FIG. 1 illustrates a schematic diagram of a system architecture, according to embodiments of the disclosure. The system architecture includes at least a terminal device 101, a blockchain 102, a payment front-end device 103, and an off-chain payment system 104.

The terminal device 101 is installed with a target application for transaction processing. The application may be a pre-installed client, a web application, or a small program embedded in other applications. The terminal device 101 may be a smart phone, a tablet computer, a notebook computer, a desktop computer, etc., which is not limited in the disclosure.

The blockchain 102, payment front-end device 103, and off-chain payment system 104 are the backend servers of the target application and provide services for the target application. Blockchain 102 may be an independent physical server, a server cluster, or a distributed system including multiple physical servers, or may be a cloud server for providing basic cloud computing services, such as cloud services, cloud databases, cloud computing, cloud functions, cloud storage, network services, cloud communications, middleware services, domain name services, security services, content delivery network (CDN), big data, artificial intelligence platforms, etc.

The payment front-end device 103 may be an independent physical server, a server cluster, or distributed system including multiple physical servers, or may be a cloud server for providing basic cloud computing services, such as cloud services, cloud databases, cloud computing, cloud functions, cloud storage, network services, cloud communications, middleware services, domain name services, security services, CDN, big data, artificial intelligence platforms, etc.

The off-chain payment system 104 may be an independent physical server, a server cluster, or distributed system including multiple physical servers, or may be a cloud server for providing basic cloud computing services, such as cloud services, cloud databases, cloud computing, cloud functions, cloud storage, network services, cloud communications, middleware services, domain name services, security services, CDN, big data, artificial intelligence platforms, etc.

The terminal device 101 and the blockchain 102 may be connected directly or indirectly through wired or wireless communication, which is not limited in the disclosure. The blockchain 102 and the payment front-end device 103 may be connected directly or indirectly through wired or wireless communication, which is not limited in the disclosure. The payment front-end device 103 and the off-chain payment system 104 may be connected directly or indirectly through wired or wireless communications, which is not limited in the disclosure.

Responsive to a client's transaction processing operation, the terminal device 101 sends a transaction processing request to the blockchain 102. The transaction processing request includes at least a sender account, a recipient account, and a payment amount.

The blockchain 102 sends the transaction request to the payment front-end device 103. When receiving the transaction request sent by the blockchain 102, the payment front-end device 103 sends a corresponding transaction pre-processing request to the off-chain payment system 104. The off-chain payment system 104 performs a corresponding transaction pre-processing operation, to obtain a transaction pre-processing outcome. The payment front-end device 103 receives the transaction pre-processing outcome sent by the off-chain payment system, and sends the transaction pre-processing outcome to the blockchain 102. Based on the transaction pre-processing outcome, the blockchain 102 performs an on-chain processing operation for the transaction request, obtains an on-chain transaction outcome, and performs consensus confirmation on the on-chain transaction outcome. When the payment front-end device 103 detects the on-chain transaction outcome corresponding to the transaction request generated by the blockchain, the payment front-end device sends a transaction instruction note to the off-chain payment system 104. The off-chain payment system 104 performs the corresponding off-chain processing operation based on the transaction instruction note to obtain an off-chain transaction outcome corresponding to the transaction request.

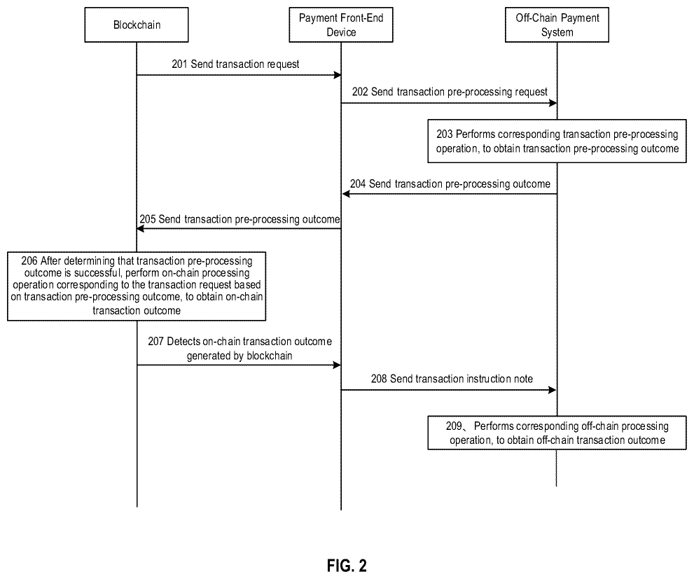

Based on the system architecture shown in FIG. 1, embodiments of the disclosure provide a flowchart of a transaction processing method. As shown in FIG. 2, the flowchart of the method is interactively executed by the blockchain 102, the payment front-end device 103, and the off-chain payment system 104, and includes the following steps.

Step S201: The blockchain sends a transaction request to the payment front-end device.

Specifically, the transaction request may be sent directly by the blockchain, or may be sent by the blockchain by calling an oracle on the payment front-end device through a smart contract.

The transaction request includes two parts: the first part is the call metadata information, which includes one or more of the following: on-chain transaction identifier, contract name, calling sequence number, etc. The second part is the transaction parameters, which include one or more of the following: sender account, payment amount, recipient account, signature, digital currency string, and so on.

The sender account or the recipient account may be a bank card account, offline QR code, offline barcode, or offline near-field communication (NFC) application. The sender account or the recipient account may also be a payment token obtained by a client terminal from a token service provider through the payment front-end device. Additionally, the sender account or the recipient account may be a sending or receiving address obtained by the client terminal through a digital currency wallet, which is not limited in the disclosure.

When a client terminal applies for a payment token from a token service provider, the client terminal submits the client's bank card account information and a token application request through the payment front-end device or a webpage of another payment service provider. The payment front-end device or other payment service provider acts as a payment token requesting entity to apply for a payment token to the token service provider. After the token service provider completes the verification of the account information submitted by the client terminal, the token service provider issues a payment token to the payment token requester, and the payment token requester returns the payment token to the client terminal or directly registers the payment token in the blockchain.

Step S202: The payment front-end device sends a corresponding transaction pre-processing request to the off-chain payment system.

Specifically, the payment front-end device is specifically placed between the blockchain and the off-chain payment system. The payment front-end device may be implemented in a centralized, distributed, or decentralized manner.

In some embodiments, the transaction pre-processing request includes a request to lock a payment amount in the sender account.

For example, if the sender account is bank card account A and the payment amount is 100 yuan, the content of the transaction pre-processing request includes: Lock 100 yuan in bank card account A.

In some embodiments, the transaction pre-processing request includes a request to control the sender account to transfer the payment amount to the recipient account and lock the payment amount in the recipient account.

For example, if the sender account is bank card account A, the payment amount is 100 yuan, and the recipient account is bank card account B, then the content of the transaction pre-processing request includes: Control bank card account A to transfer 100 yuan to bank card account B and lock the 100 yuan in bank card account B.

In some embodiments, the transaction pre-processing request includes a request to lock a digital currency string corresponding to the sender address.

For example, the sender account is the sender address A. The sender address A contains a digital currency string, and the payment amount corresponding to the digital currency string is 100 yuan. If the recipient account is recipient address B, then the content of the transaction pre-processing request includes: Lock the digital currency string in the sender address A.

In some embodiments, the transaction pre-processing request includes a request to control the transfer of the digital currency string corresponding to the payment amount from the sender address to the recipient address and lock the digital currency string in the recipient address.

For example, the sender account is the sender address A. The sender address A contains a digital currency string, and the payment amount corresponding to the digital currency string is 100 yuan. If the recipient account is recipient address B, then the content of the transaction pre-processing request includes: Transfer the digital currency string in the sender address A from the sender address A to the recipient address B and lock the digital currency string in the recipient address B.

Optionally, when the payment front-end device determines that an on-chain transaction identifier, contract name, and call sequence number in the received transaction request are the same as an on-chain transaction identifier, contract name, and call sequence number in a historical transaction request, the payment front-end device then determines whether a transaction pre-processing outcome corresponding to the transaction request has been cached. If the transaction pre-processing outcome corresponding to the transaction request has been cached, the transaction pre-processing outcome corresponding to the cached transaction request will be sent to the blockchain. Otherwise, wait for the off-chain payment system to return a transaction pre-processing outcome corresponding to the transaction request. When the payment front-end device determines that the on-chain transaction identifier, contract name, and call sequence number in the received transaction request are different from an on-chain transaction identifier, contract name, and call sequence number in the historical transaction requests, proceed to Step S203.

Step S203: The off-chain payment system performs a corresponding transaction pre-processing operation, to obtain a transaction pre-processing outcome.

In some embodiments, when the transaction pre-processing request includes a request to lock the payment amount in the sender account, the off-chain payment system locks the payment amount in the sender account, to obtain a transaction pre-processing outcome.

For example, when the content of the transaction pre-processing request is to lock 100 yuan in bank card account A, the off-chain payment system performs the operation of locking 100 yuan in bank card account A, to obtain a transaction pre-processing outcome.

In some embodiments, when the transaction pre-processing request includes a request to control the sender account to transfer the payment amount to the recipient account and lock the payment amount in the recipient account, the off-chain payment system controls the sender account to transfer the payment amount to the recipient account and lock the payment amount in the recipient account, to obtain a transaction pre-processing outcome.

For example, when the content of the transaction pre-processing request is to control bank card account A to transfer 100 yuan to bank card account B and lock 100 yuan in bank card account B, the off-chain payment system controls bank card account A to transfer 100 yuan to bank card account B and locks the 100 yuan in bank card account B, to obtain a transaction pre-processing outcome.

In some embodiments, when the transaction pre-processing request includes a request to lock the digital currency string corresponding to the sender address, the off-chain payment system locks that digital currency string.

For example, when the content of the transaction pre-processing request is to lock the digital currency string in the sender address A, the off-chain payment system performs the operation of locking the digital currency string, to obtain a transaction pre-processing outcome. In some embodiments, when the transaction pre-processing request includes a request to control the transfer of the digital currency string in the sender address from the sender address to the recipient address and lock the digital currency string in the recipient address, the off-chain payment system controls the transfer of the digital currency string corresponding to the payment amount from the sender address to the recipient address and locks the digital currency string in the recipient address, to obtain a transaction pre-processing outcome.

For example, when the content of the transaction pre-processing request is to control the transfer of the digital currency string in the sender address A from the sender address A to the recipient address B and lock the digital currency string in the recipient address B, the off-chain payment system controls the transfer of the digital currency string in the sender address A from the sender address A to the recipient address B and locks the digital currency string in the recipient B, to obtain a transaction pre-processing outcome.

Step S204: The off-chain payment system sends the transaction pre-processing outcome to the payment front-end device.

Specifically, the payment front-end device locally caches the transaction pre-processing outcome and the corresponding on-chain transaction identifier.

Step S205: The payment front-end device sends the transaction pre-processing outcome to the blockchain.

Specifically, the transaction pre-processing outcome includes two possibilities: successful transaction pre-processing and unsuccessful transaction pre-processing.

For example, in some embodiments, when the content of the transaction pre-processing request is to lock 100 yuan in bank card account A, the off-chain payment system performs the operation of locking 100 yuan in bank card account A.

If there is no 100 yuan in bank card account A, or the off-chain payment system cannot lock the 100 yuan in bank card account A, then the obtained transaction pre-processing outcome is that the transaction pre-processing is unsuccessful.

If the off-chain payment system successfully locks the 100 yuan in bank card account A, then the obtained transaction pre-processing outcome is that the transaction pre-processing is successful.

In some embodiments, when the content of the transaction pre-processing request is to control bank card account A to transfer 100 yuan to bank card account B and lock the 100 yuan in bank card account B, the off-chain payment system performs the corresponding operation.

If the off-chain payment system cannot control bank card account A to transfer 100 yuan to bank card account B, or cannot lock the 100 yuan in bank card account B, then the obtained transaction pre-processing outcome is that the transaction pre-processing is unsuccessful.

If the off-chain payment system controls bank card account A to transfer 100 yuan to bank card account B and successfully locks 100 yuan in bank card account B, then the obtained transaction pre-processing outcome is that the transaction pre-processing is successful.

In some embodiments, when the content of the transaction pre-processing request is to lock the digital currency string in the sender address A, the off-chain payment system performs the corresponding operation.

If there is no digital currency string in the sender address A, or the off-chain payment system cannot lock the digital currency string in the sender address A, then the obtained transaction pre-processing outcome is that the transaction pre-processing is unsuccessful.

If the off-chain payment system successfully locks the digital currency string in the sender address A, then the obtained transaction pre-processing outcome is that the transaction pre-processing is successful.

In some embodiments, when the content of the transaction pre-processing request is to control the transfer of the digital currency string in the sender address A from the sender address A to the recipient address B and lock the digital currency string in the recipient address B, the off-chain payment system performs the corresponding operation.

If the off-chain payment system cannot control the transfer of the digital currency string in the sender address A from the sender address A to the recipient address B, or cannot lock the digital currency string in the recipient address B, then the obtained transaction pre-processing outcome is that the transaction pre-processing is unsuccessful.

If the off-chain payment system controls the transfer of the digital currency string in the sender address A from the sender address A to the recipient address B, and successfully locks the digital currency string in the recipient address B, then the obtained transaction pre-processing outcome is that the transaction pre-processing is successful.

Step S206: When the blockchain determines that the transaction pre-processing outcome is successful, the blockchain performs an on-chain processing operation corresponding to the transaction request based on the transaction pre-processing outcome to obtain an on-chain transaction outcome.

Specifically, the on-chain processing operation includes processing the transaction request based on the transaction pre-processing outcome, recording the transaction processing outcome into a block, and then confirming the block through consensus. After the block is confirmed, the transaction confirmation event is completed.

In addition, when the blockchain determines that the transaction pre-processing outcome is that the transaction pre-processing is unsuccessful, the blockchain outputs “on-chain transaction fails” and ends the process.

Step S207: The payment front-end device detects an on-chain transaction outcome generated by the blockchain.

Optionally, when it is detected that the blockchain has generated a predefined number of blocks corresponding to the transaction request, the payment front-end device determines that the on-chain transaction outcome corresponding to the transaction request indicates a successful on-chain transaction. Otherwise, the payment front-end device determines that the on-chain transaction outcome corresponding to the transaction request indicates an unsuccessful on-chain transaction. Here, the predefined number of blocks is determined based on the configuration information of the consensus algorithm or endorsement strategy in the blockchain.

Specifically, the predefined number in the consensus algorithm may be a specific value, or it may be adjusted according to the number of blocks on the blockchain.

Step S208: The payment front-end device sends a transaction instruction note to the off-chain payment system.

In some embodiments, the transaction pre-processing operation is to lock the payment amount in the sender account. When the payment front-end device detects that the on-chain transaction outcome indicates a successful on-chain transaction, the payment front-end device sends a first transaction instruction note to the off-chain payment system. The first transaction instruction note is used to instruct the off-chain payment system to control the sender account to transfer the payment amount to the recipient account in the transaction request, to obtain a first off-chain transaction outcome.

When the payment front-end device detects that the on-chain transaction outcome indicates an unsuccessful on-chain transaction, the payment front-end device sends a second transaction instruction note to the off-chain payment system. The second transaction instruction note is used to instruct the off-chain payment system to release the payment amount in the sender account, to obtain a second off-chain transaction outcome.

For example, if the transaction pre-processing operation is to lock 100 yuan in bank card account A, when the payment front-end device detects that the on-chain transaction outcome indicates a successful on-chain transaction, the payment front-end device sends a first transaction instruction note to the off-chain payment system, that is, to instruct the off-chain payment system to control bank card account A to transfer 100 yuan to bank card account B.

When the payment front-end device detects that the on-chain transaction outcome indicates an unsuccessful on-chain transaction, the payment front-end device sends a second transaction instruction note to the off-chain payment system, that is, to instruct the off-chain payment system to release the 100 yuan in bank card account A.

In some embodiments, the transaction pre-processing operation is to control the sender account to transfer the payment amount to the recipient account and lock the payment amount in the recipient account. When the payment front-end device detects that the on-chain transaction outcome indicates a successful on-chain transaction, the payment front-end device sends a third transaction instruction note to the off-chain payment system. The third transaction instruction note is used to instruct the off-chain payment system to release the payment amount in the recipient account, to obtain a third off-chain transaction outcome.

When the payment front-end device detects that the on-chain transaction outcome indicates an unsuccessful on-chain transaction, the payment front-end device sends a fourth transaction instruction note to the off-chain payment system. The fourth transaction instruction note is used to instruct the off-chain payment system to control the recipient account to return the payment amount to the sender account, to obtain a fourth off-chain transaction outcome.

For example, if the transaction pre-processing operation is to control bank card account A to transfer 100 yuan to bank card account B and lock the 100 yuan in bank card account B, when the payment front-end device detects that the on-chain transaction outcome indicates a successful on-chain transaction, the payment front-end device sends a third transaction instruction note to the off-chain payment system, that is, to instruct the off-chain payment system to release the 100 yuan in bank card account B.

When the payment front-end device detects that the on-chain transaction outcome indicates an unsuccessful on-chain transaction, the payment front-end device sends a fourth transaction instruction note to the off-chain payment system, that is, to instruct the off-chain payment system to control bank card account B to return 100 yuan to bank card account A.

In some embodiments, the transaction pre-processing operation is to lock the digital currency string corresponding to a payment amount in the sender address. When the payment front-end device detects that the on-chain transaction outcome indicates a successful on-chain transaction, the payment front-end device sends a fifth transaction instruction note to the off-chain payment system. The fifth transaction instruction note is used to instruct the off-chain payment system to control the transfer of the digital currency string from the sender address to the recipient address, to obtain a fifth off-chain transaction outcome.

When the payment front-end device detects that the on-chain transaction outcome indicates an unsuccessful on-chain transaction, the payment front-end device sends a sixth transaction instruction note to the off-chain payment system. The sixth transaction instruction note is used to instruct the off-chain payment system to release the digital currency string corresponding to the payment amount in the sender address, to obtain a sixth off-chain transaction outcome.

For example, if the transaction pre-processing operation is to lock the digital currency string in the sender address A, when the payment front-end device detects that the on-chain transaction outcome indicates a successful on-chain transaction, the payment front-end device sends a fifth transaction instruction note to the off-chain payment system, that is, to instruct the off-chain payment system to control the transfer of the digital currency string in the sender address A from the sender address A to the recipient address B.

When the payment front-end device detects that the on-chain transaction outcome indicates an unsuccessful on-chain transaction, the payment front-end device sends a sixth transaction instruction note to the off-chain payment system, that is, to instruct the off-chain payment system to release the digital currency string in the sender address A.

In some embodiments, the transaction pre-processing operation is to control the transfer of the digital currency string corresponding to a payment amount from the sender address to the recipient address and lock the digital currency string in the recipient address. When the payment front-end device detects that the on-chain transaction outcome indicates a successful on-chain transaction, the payment front-end device sends a seventh transaction instruction note to the off-chain payment system. The seventh transaction instruction note is used to instruct the off-chain payment system to release the digital currency string in the recipient address, to obtain a seventh off-chain transaction outcome.

When the payment front-end device detects that the on-chain transaction outcome indicates an unsuccessful on-chain transaction, the payment front-end device sends an eighth transaction instruction note to the off-chain payment system. The eighth transaction instruction note is used to instruct the off-chain payment system to control the transfer of the digital currency string from the recipient address to the sender address, to obtain an eighth off-chain transaction outcome.

For example, if the transaction pre-processing operation is to control the transfer of the digital currency string in the sender address A from the sender address A to the recipient address B and lock the digital currency string in the recipient address B, when the payment front-end device detects that the on-chain transaction outcome indicates a successful on-chain transaction, the payment front-end device sends a seventh transaction instruction note to the off-chain payment system, that is, to instruct the off-chain payment system to release the digital currency string in the recipient address B.

When the payment front-end device detects that the on-chain transaction outcome indicates an unsuccessful on-chain transaction, the payment front-end device sends an eighth transaction instruction note to the off-chain payment system, that is, to instruct the off-chain payment system to control the digital currency string in the sender address B to transfer from the recipient address B to the sender address A.

Step S209: The off-chain payment system performs a corresponding off-chain processing operation to obtain an off-chain transaction outcome.

In some embodiments, when the off-chain payment system receives the first transaction instruction note, the off-chain payment system controls the sender account to transfer the payment amount to the recipient account in the transaction request, to obtain the first off-chain transaction outcome. When the off-chain payment system receives the second transaction instruction note, the off-chain payment system releases the payment amount in the sender account, to obtain the second off-chain transaction outcome.

For example, if the transaction pre-processing operation is to lock 100 yuan in bank card account A, when the off-chain payment system receives the first instruction note, the off-chain payment system controls bank card account A to transfer 100 yuan to bank card account B, to obtain the first off-chain transaction outcome.

When the off-chain payment system receives the second transaction instruction note, the off-chain payment system releases the 100 yuan in bank card account A.

In some embodiments, when the off-chain payment system receives the third transaction instruction note, the off-chain payment system releases the payment amount in the recipient account, to obtain the third off-chain transaction outcome. When the off-chain payment system receives the fourth transaction instruction note, the off-chain payment system controls the recipient account to return the payment amount to the sender account.

For example, if the transaction pre-processing operation is to control bank card account A to transfer 100 yuan to bank card account B and lock the 100 yuan in bank card account B, when the off-chain payment system receives the third instruction note, the off-chain payment system releases the 100 yuan in bank card account B.

When the off-chain payment system receives the fourth instruction note, the off-chain payment system controls bank card account B to return 100 yuan to bank card account A.

In some embodiments, when the off-chain payment system receives the fifth transaction instruction note, the off-chain payment system controls the transfer of the digital currency string from the sender address to the recipient address, to obtain a fifth off-chain transaction outcome. When the off-chain payment system receives the sixth transaction instruction note, the off-chain payment system releases the corresponding digital currency string in the sender address, to obtain the sixth off-chain transaction outcome.

For example, if the transaction pre-processing operation is to lock the digital currency string in the sender address A, when the off-chain payment system receives the fifth instruction note, the off-chain payment system controls to transfer the digital currency string in the sender address A from the sender address A to the recipient address B, to obtain the fifth off-chain transaction outcome.

When the off-chain payment system receives the sixth instruction note, the off-chain payment system releases the digital currency string in the sender address A.

In some embodiments, when the off-chain payment system receives the seventh transaction instruction note, the off-chain payment system releases the digital currency string in the recipient address, to obtain the seventh off-chain transaction outcome. When the off-chain payment system receives the eighth transaction instruction note, the off-chain payment system controls the transfer of the digital currency string from the recipient address to the sender address, to obtain the eighth off-chain transaction outcome.

For example, if the transaction pre-processing operation is to control the transfer of the digital currency string in the sender address A from the sender address A to the recipient address B and lock the digital currency string in the recipient address B, when the off-chain payment system receives the seventh instruction note, the off-chain payment system releases the digital currency string in the recipient address B.

When the off-chain payment system receives the eighth instruction note, the off-chain payment system controls the transfer of the digital currency string in the recipient address B from the recipient address B to the sender address A.

In the embodiments of the disclosure, when the payment front-end device receives a transaction request sent by the blockchain, the payment front-end device sends a corresponding transaction pre-processing request to the off-chain payment system. The off-chain payment system performs a corresponding transaction pre-processing operation, to obtain a transaction pre-processing outcome. The sender account or recipient account in the transaction request is one of many types of offline payment accounts. Therefore, the payment transaction method in the disclosure is adapted to many types of off-chain payment systems, to meet the usage of different types of payment accounts, which enhances the versatility of the payment transaction methods provided in the disclosure.

The payment front-end device receives the transaction pre-processing outcome sent by the off-chain payment system and sends the transaction pre-processing outcome to the blockchain. When it is detected that the blockchain has generated an on-chain transaction outcome corresponding to the transaction request, a transaction instruction note is sent to the off-chain payment system. The transaction instruction note is used to instruct the off-chain payment system to perform a corresponding off-chain processing operation to obtain an off-chain transaction outcome corresponding to the transaction request. The on-chain transaction outcome is obtained by the blockchain that performs an on-chain processing operation for the transaction request based on the transaction pre-processing outcome. The transaction processing method provided by the disclosure realizes the payment transaction within an alliance chain. The payment transaction is processed based on both the on-chain transaction and the off-chain transaction. That is, based on the transaction pre-processing outcome of the off-chain transaction, the blockchain performs the on-chain transaction for the transaction request to obtain the on-chain transaction outcome. The off-chain payment system then performs the off-chain transaction for the transaction request based on the on-chain transaction outcome to obtain the off-chain transaction outcome. The on-chain transaction may initiate a transaction request through a smart contract, thereby ensuring that the on-chain transaction is performed in a trusted environment. Since the on-chain transaction and off-chain transaction are performed interactively, the credibility and security of the off-chain transaction are also guaranteed, and erroneous transactions caused by human errors that exist when only the off-chain transaction is performed may be avoided.

Optionally, in the above Step S203, the payment front-end device receives an encrypted transaction request sent by the blockchain, where the transaction request is encrypted by the blockchain based on the public key of the payment front-end device. The payment front-end device decrypts the transaction request, obtains the transaction information in the transaction request, then generates a transaction pre-processing request based on the transaction information, and sends the transaction pre-processing request to the off-chain payment system.

Specifically, the encryption algorithm may be a symmetric encryption algorithm or an asymmetric encryption algorithm. In symmetric encryption algorithms, the data sender and data recipient use the same set of rules to encrypt and decrypt data. Asymmetric encryption uses a key pair to encrypt and decrypt data. The key pair contains a public key and a private key. Asymmetric encryption algorithms may generally be divided into three main methods: large integer decomposition problem method, discrete logarithm problem method, and elliptic curve method. Asymmetric encryption algorithms in blockchain mainly use elliptic curve encryption algorithms that use plane elliptic curves to calculate groups of asymmetric special values.

In the embodiments of the disclosure, the blockchain uses a public key of the payment front-end device to encrypt the transaction request, and then sends the encrypted transaction request to the payment front-end device. If the encrypted transaction request is intercepted by a third party, the third party may only see random numbers and letters and may not obtain the information in the transaction request. The payment front-end device receives the encrypted transaction request, and uses its own private key to decrypt the transaction request to obtain the transaction information in the transaction request.

In the present disclosure, an asymmetric encryption algorithm is used to encrypt the transaction request. Since the asymmetric encryption algorithm uses a key pair to encrypt and decrypt the data, the public key in the key pair is made public and the private key is kept private, making the security higher. While ensuring the security of the transaction request, this approach also solves the key transmission problems.

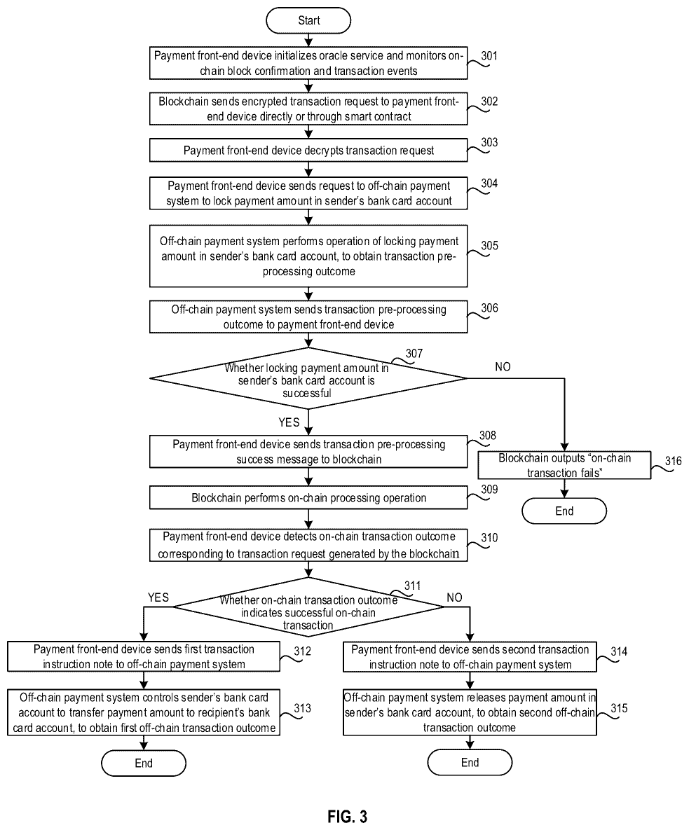

To better explain the embodiments of the present disclosure, a transaction processing method provided by the embodiments of the present disclosure is described hereinafter in conjunction with a specific transfer scenario. The method is interactively performed by the blockchain, the payment front-end device, and the off-chain payment system. Assume that a sender account is a bank card account. As shown in FIG. 3, the method includes the following steps.

Step S301: The payment front-end device initializes an oracle service and monitors on-chain block confirmation and transaction events.

Step S302: The blockchain sends an encrypted transaction request to the payment front-end device directly or through a smart contract.

The transaction request includes at least a sender's bank card account and a payment amount.

Step S303: The payment front-end device decrypts the transaction request.

The payment front-end device determines whether the on-chain transaction identifier, contract name, and call sequence number included in the transaction request are consistent with an on-chain transaction identifier, contract name, and call sequence number contained in a historical transaction request. If inconsistent, proceed to Step S304.

If consistent, it is determined whether a transaction pre-processing outcome corresponding to the transaction request has been cached. If the transaction pre-processing outcome has been cached, proceed to Step S307; if not cached, wait for the off-chain payment system to return the transaction pre-processing outcome corresponding to the transaction request, then proceed to Step S307.

Step S304: The payment front-end device sends a request to the off-chain payment system to lock the payment amount in the sender's bank card account.

Step S305: The off-chain payment system performs an operation of locking the payment amount in the sender's bank card account, to obtain a transaction pre-processing outcome.

Step S306: The off-chain payment system sends the transaction pre-processing outcome to the payment front-end device.

Step S307: The payment front-end device determines whether the operation of locking the payment amount in the sender's bank card account is successful. If successful, proceed to Step S308; otherwise, proceed to Step S316.

Step S308: The payment front-end device sends a transaction pre-processing success message to the blockchain.

Step S309: The blockchain performs an on-chain processing operation, to obtain an on-chain transaction outcome.

The on-chain processing operation includes processing the transaction request based on the transaction pre-processing outcome, recording the transaction processing outcome into a block, and then confirming the block through consensus. After the block is confirmed, the transaction confirmation event is completed.

Step S310: The payment front-end device detects the on-chain transaction outcome corresponding to the transaction request generated by the blockchain.

Step S311: The payment front-end device determines whether the on-chain transaction outcome indicates a successful on-chain transaction. If successful, proceed to Step S312. Otherwise, proceed to Step S314.

When it is detected that the blockchain has generated a predefined number of blocks corresponding to the transaction request, determine that the on-chain transaction outcome corresponding to the transaction request indicates a successful on-chain transaction. Otherwise, determine that the on-chain transaction outcome corresponding to the transaction request indicates an unsuccessful on-chain transaction. Here, the predefined number is determined based on the configuration information of the consensus algorithm or endorsement strategy in the blockchain.

Step S312: The payment front-end device sends a first transaction instruction note to the off-chain payment system.

The first transaction instruction note is used to instruct the off-chain payment system to control the sender's bank card account to transfer the payment amount to the recipient's bank card account.

Step S313: The off-chain payment system controls the sender's bank card account to transfer the payment amount to the recipient's bank card account, to obtain a first off-chain transaction outcome.

Step S314: The payment front-end device sends a second transaction instruction note to the off-chain payment system.

The second transaction instruction note is used to instruct the off-chain payment system to release the payment amount in the sender's bank card account.

Step S315: The off-chain payment system releases the payment amount in the sender's bank card account, to obtain a second off-chain transaction outcome.

Step S316: The blockchain outputs “on-chain transaction fails”.

In the embodiments of the disclosure, when performing a payment transaction, the off-chain payment system first locks the payment amount of the sender, to obtain a transaction pre-processing outcome. After the blockchain obtains the transaction pre-processing outcome through the payment front-end device, the blockchain performs the on-chain transaction operation corresponding to the transaction request based on the transaction pre-processing outcome. The off-chain payment system performs the corresponding off-chain transaction operation to obtain the off-chain transaction outcome. Since the blockchain performs the on-chain transaction through a smart contract, it ensures that the on-chain transaction is performed in a trusted environment. Since the on-chain transaction and off-chain transaction are performed interactively, the credibility and security of the off-chain transaction are also ensured, and erroneous transactions caused by human errors are avoided.

In addition, when conducting a payment transaction, the payment amount in the sender account is first locked, and then the corresponding on-chain transaction processing and off-chain transaction processing are performed based on whether the lock is successful, thereby ensuring the accuracy of the subsequent transactions while avoiding invalid processing.

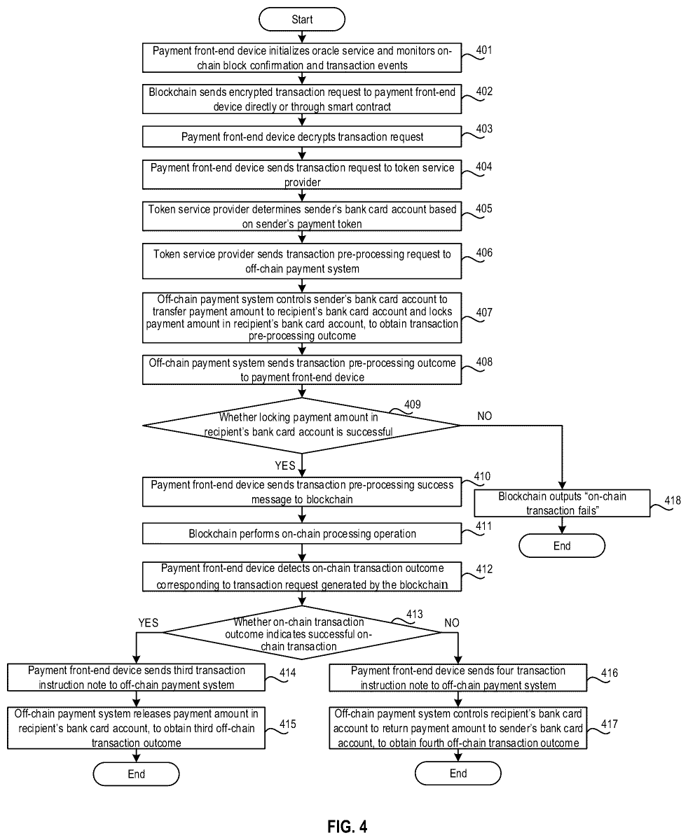

To better explain the embodiments of the present disclosure, another transaction processing method provided by the embodiments of the present disclosure is described hereinafter in conjunction with another specific transfer scenario. The method is interactively performed by the blockchain, the payment front-end device, and the off-chain payment system. Assume that the sender account is a payment token, and the recipient account is an offline QR code of a merchant. As shown in FIG. 4, the method includes the following steps.

Step S401: The payment front-end device initializes an oracle service and monitors on-chain block confirmation and transaction events.

Step S402: The blockchain sends an encrypted transaction request to the payment front-end device directly or through a smart contract.

The transaction request includes at least a sender's payment token, a recipient's offline QR code, and a payment amount.

Step S403: The payment front-end device decrypts the transaction request.

The payment front-end device determines whether the on-chain transaction identifier, contract name, and call sequence number included in the transaction request are consistent with an on-chain transaction identifier, contract name, and call sequence number contained in a historical transaction request. If inconsistent, proceed to Step S404.

If consistent, determine whether a transaction pre-processing outcome corresponding to the transaction request has been cached. If cached, proceed to Step S409; if not cached, wait for the off-chain payment system to return a transaction pre-processing outcome corresponding to the transaction request, and proceed to Step S409.

Step S404: The payment front-end device sends the transaction request to a token service provider.

Step S405: The token service provider determines the sender's bank card account based on the sender's payment token.

Step S406: The token service provider sends a transaction pre-processing request to the off-chain payment system.

The content of the transaction pre-processing request includes the sender's bank card account paying the payment amount to the recipient's bank card account corresponding to the offline QR code and locking the payment amount in the recipient's bank card account.

Step S407: The off-chain payment system controls the sender's bank card account to transfer the payment amount to the recipient's bank card account and locks the payment amount in the recipient's bank card account, to obtain a transaction pre-processing outcome.

Step S408: The off-chain payment system sends the transaction pre-processing outcome to the payment front-end device.

Step S409: The payment front-end device determines whether the sender's bank card account paying the payment amount to the recipient's bank card account and locking the payment amount in the recipient's bank card account are successful. If successful, proceed to Step S410; otherwise, proceed to Step S418.

Step S410: The payment front-end device sends a transaction pre-processing success message to the blockchain.

Step S411: The blockchain performs an on-chain processing operation to obtain an on-chain transaction outcome.

The on-chain processing operation includes processing the transaction request based on the transaction pre-processing outcome, recording the transaction processing outcome into a block, and then confirming the block through consensus. After the block is confirmed, the transaction confirmation event is completed.

Step S412: The payment front-end device detects the on-chain transaction outcome corresponding to the transaction request generated by the blockchain.

Step S413: The payment front-end device determines whether the on-chain transaction outcome indicates a successful on-chain transaction. If successful, proceed to Step S414; otherwise, proceed to Step S416.

When it is detected that the blockchain has generated a predefined number of blocks corresponding to the transaction request, determine that the on-chain transaction outcome corresponding to the transaction request indicates a successful on-chain transaction. Otherwise, determine that the on-chain transaction outcome corresponding to the transaction request indicates an unsuccessful on-chain transaction. Here, the predefined number is determined based on the configuration information of the consensus algorithm or endorsement strategy in the blockchain.

Step S414: The payment front-end device sends a third transaction instruction note to the off-chain payment system.

The third transaction instruction note is used to instruct the off-chain payment system to release the payment amount in the recipient's bank card account.

Step S415: The off-chain payment system releases the payment amount in the recipient's bank card account, to obtain a third off-chain transaction outcome.

Step S416: The payment front-end device sends a fourth transaction instruction note to the off-chain payment system.

The fourth transaction instruction note is used to instruct the off-chain payment system to control the recipient's bank card account to return the payment amount to the sender's bank card account.

Step S417: The off-chain payment system controls the recipient's bank card account to return the payment amount to the sender's bank card account, to obtain a fourth off-chain transaction outcome.

Step S418: The blockchain outputs “on-chain transaction fails”.

In the embodiments of the disclosure, when performing a payment transaction, the off-chain payment system first controls the sender's bank card account to transfer the payment amount to the recipient's bank card account, then locks the payment amount in the recipient's bank card account, to obtain a transaction pre-processing outcome. After the blockchain obtains the transaction pre-processing outcome through the payment front-end device, the blockchain performs the on-chain transaction operation corresponding to the transaction request based on the transaction pre-processing outcome. The off-chain payment system performs the corresponding off-chain transaction operation to obtain the off-chain transaction outcome. Since the blockchain performs the on-chain transaction through a smart contract, it ensures that the on-chain transaction is performed in a trusted environment. Since the on-chain transaction and the off-chain transaction are performed interactively, the credibility and security of off-chain transactions are also ensured, and erroneous transactions caused by human errors are avoided.

In addition, in the disclosed embodiment, the payment token is used to replace the bank card account in the transaction request, which avoids leakage of the bank card account and ensures the security of the transaction. Meanwhile, using a unified format of payment tokens to replace various bank card account information may improve compatibility in payment transactions and improve the flexibility of managing different types of transaction accounts.

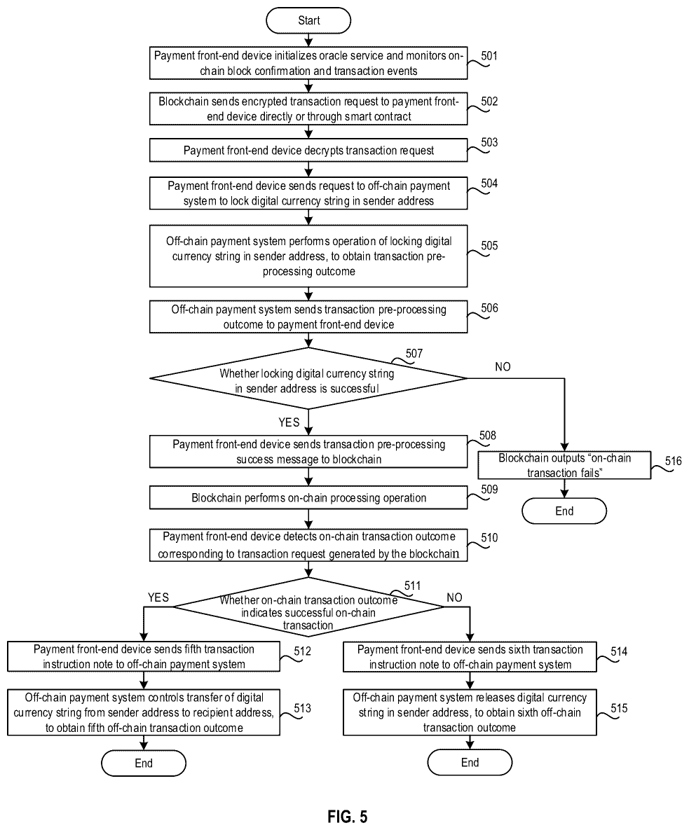

To better explain the embodiments of the present disclosure, another transaction processing method provided by the embodiments of the present disclosure is described below in conjunction with another specific transfer scenario. The method is interactively performed by the blockchain, the payment front-end device, and the off-chain payment system. Assume that the sender account is the sender address and the recipient account is the recipient address. As shown in FIG. 5, the method includes the following steps.

Step S501: The payment front-end device initializes an oracle service and monitors on-chain block confirmation and transaction events.

Step S502: The blockchain sends an encrypted transaction request to the payment front-end device directly or through a smart contract.

The transaction request includes the sender address, a digital currency string in the sender address, and the recipient address. The digital currency string includes a payment amount.

Step S503: The payment front-end device decrypts the transaction request.

The payment front-end device determines whether the on-chain transaction identifier, contract name, and call sequence number included in the transaction request are consistent with an on-chain transaction identifier, contract name, and call sequence number contained in a historical transaction request. If inconsistent, proceed to Step S504.

If consistent, determine whether the transaction pre-processing outcome corresponding to the transaction request has been cached. If cached, proceed to Step S507; if not cached, wait for the off-chain payment system to return a transaction pre-processing outcome corresponding to the transaction request, and proceed to Step S507.

Step S504: The payment front-end device sends a request to the off-chain payment system to lock the digital currency string in the sender address.

Step S505: The off-chain payment system performs an operation of locking the digital currency string in the sender address, to obtain a transaction pre-processing outcome.

Step S506: The off-chain payment system sends the transaction pre-processing outcome to the payment front-end device.

Step S507: The payment front-end device determines whether the operation of locking the digital currency string in the sender address is successful. If successful, proceed to Step S508; otherwise, proceed to Step S516.

Step S508: The payment front-end device sends a transaction pre-processing success message to the blockchain.

Step S509: The blockchain performs an on-chain processing operation to obtain an on-chain transaction outcome.

The on-chain processing operation includes processing the transaction request based on the transaction pre-processing outcome, recording the transaction processing outcome into a block, and then confirming the block through consensus. After the block is confirmed, the transaction confirmation event is completed.

Step S510: The payment front-end device detects the on-chain transaction outcome corresponding to the transaction request generated by the blockchain.

Step S511: The payment front-end device determines whether the on-chain transaction outcome indicates a successful on-chain transaction. If successful, proceed to Step S512; otherwise, proceed to Step S514.

When it is detected that the blockchain has generated a predefined number of blocks corresponding to the transaction request, determine that the on-chain transaction outcome corresponding to the transaction request indicates a successful on-chain transaction. Otherwise, determine that the on-chain transaction outcome corresponding to the transaction request indicates an unsuccessful on-chain transaction. Here the predefined number is determined based on the configuration information of the consensus algorithm or endorsement strategy in the blockchain.

Step S512: The payment front-end device sends a fifth transaction instruction note to the off-chain payment system.

The fifth transaction instruction note is used to instruct the off-chain payment system to control the transfer of the digital currency string from the sender address to the recipient address.

Step S513: The off-chain payment system controls the transfer of the digital currency string from the sender address to the recipient address, to obtain a fifth off-chain transaction outcome.

Step S514: The payment front-end device sends a sixth transaction instruction note to the off-chain payment system.

The sixth transaction instruction note is used to instruct the off-chain payment system to release the digital currency string in the sender address.

Step S515: The off-chain payment system releases the digital currency string in the sender address, to obtain a sixth off-chain transaction outcome.

Step S516: The blockchain outputs “on-chain transaction fails”.

In the embodiments of the disclosure, when performing a payment transaction, the off-chain payment system first locks the digital currency string in the sender address, to obtain a transaction pre-processing outcome. After obtaining the transaction pre-processing outcome through the payment front-end device, the blockchain performs an on-chain transaction operation corresponding to the transaction request based on the transaction pre-processing outcome. The off-chain payment system performs the corresponding off-chain transaction operation to obtain an off-chain transaction outcome. Since the blockchain performs the on-chain transaction through a smart contract, it ensures that the on-chain transaction is performed in a trusted environment. Since the on-chain transaction and the off-chain transaction are performed interactively, the credibility and security of off-chain transactions are also ensured, and erroneous transactions caused by human errors are avoided.

In addition, when conducting a payment transaction, the digital currency in the sender address is first locked, and then the corresponding on-chain transaction processing and off-chain transaction processing are performed based on whether the lock is successful, ensuring the accuracy of subsequent transactions while avoiding invalid processing.

Furthermore, due to the usage of digital currency for transactions, it is more conducive to building an interactive system for on-chain transactions and off-chain transactions. Meanwhile, in the absence of a network, digital currency transactions may be directly paid offline, lifting the restrictions for places with poor network signals.

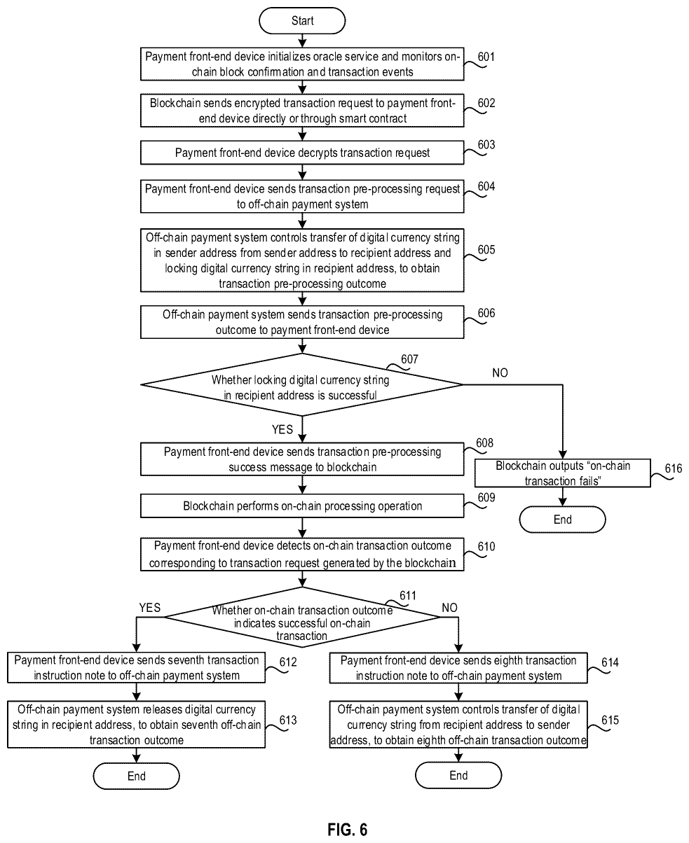

To better explain the embodiments of the present disclosure, another transaction processing method provided by the embodiments of the present disclosure is described hereinafter in conjunction with another specific transfer scenario. The method is interactively performed by the blockchain, the payment front-end device, and the off-chain payment system. It is assumed that the sender account is the sender address, and the recipient account is the recipient address. As shown in FIG. 6, the method includes the following steps.

Step S601: The payment front-end device initializes an oracle service and monitors on-chain block confirmation and transaction events.

Step S602: The blockchain sends an encrypted transaction request to the payment front-end device directly or through a smart contract.

The transaction request includes the sender address, a digital currency string in the sender address, and the recipient address. The digital currency string includes a payment amount.

Step S603: The payment front-end device decrypts the transaction request.

The payment front-end device determines whether the on-chain transaction identifier, contract name, and call sequence number included in the transaction request are consistent with an on-chain transaction identifier, contract name, and call sequence number contained in a historical transaction request. If inconsistent, proceed to Step S604.

If consistent, determine whether a transaction pre-processing outcome corresponding to the transaction request has been cached. If cached, proceed to Step S607; if not cached, wait for the off-chain payment system to return a transaction pre-processing outcome corresponding to the transaction request, and proceed to Step S607.

Step S604: The payment front-end device sends a transaction pre-processing request to the off-chain payment system.

The content of the transaction pre-processing request includes transferring the digital currency string in the sender address from the sender address to the recipient address and locking the digital currency string in the recipient address.

Step S605: The off-chain payment system controls the transfer of the digital currency string in the sender address from the sender address to the recipient address and locks the digital currency string in the recipient address, to obtain a transaction pre-processing outcome.

Step S606: The off-chain payment system sends the transaction pre-processing outcome to the payment front-end device.

Step S607: The payment front-end device determines whether the transfer of the digital currency string in the sender address from the sender address to the recipient address and locking the digital currency string in the recipient address are successful. If successful, proceed to Step S608; otherwise, proceed to Step S616.

Step S608: The payment front-end device sends a transaction pre-processing success message to the blockchain.

Step S609: The blockchain performs an on-chain processing operation to obtain an on-chain transaction outcome.

The on-chain processing operation includes processing the transaction request based on the transaction pre-processing outcome, recording the transaction processing outcome into a block, and then confirming the block through consensus. After the block is confirmed, the transaction confirmation event is completed.

Step S610: The payment front-end device detects the on-chain transaction outcome corresponding to the transaction request generated by the blockchain.

Step S611: The payment front-end device determines whether the on-chain transaction outcome indicates a successful on-chain transaction. If successful, proceed to Step S612; otherwise, proceed to Step S614.

When it is detected that the blockchain has generated a predefined number of blocks corresponding to the transaction request, determine that the on-chain transaction outcome corresponding to the transaction request indicates a successful on-chain transaction. Otherwise, determine that the on-chain transaction outcome corresponding to the transaction request indicates an unsuccessful on-chain transaction. Here the predefined number is determined based on the configuration information of the consensus algorithm or endorsement strategy in the blockchain.

Step S612: The payment front-end device sends a seventh transaction instruction note to the off-chain payment system.

The seventh transaction instruction note is used to instruct the off-chain payment system to release the digital currency string in the recipient address.

Step S613: The off-chain payment system releases the digital currency string in the recipient address, to obtain a seventh off-chain transaction outcome.

Step S614: The payment front-end device sends an eighth transaction instruction note to the off-chain payment system.

The eighth transaction instruction note is used to instruct the off-chain payment system to control the transfer of the digital currency string in the recipient address to the sender address.

Step S615: The off-chain payment system controls the transfer of the digital currency string from the recipient address to the sender address, to obtain an eighth off-chain transaction outcome.

Step S616: The blockchain outputs “on-chain transaction fails”.

In the embodiments of the disclosure, since the blockchain performs the on-chain transaction through a smart contract, it is ensured that the on-chain transaction is performed in a trusted environment. Since the on-chain transaction and the off-chain transaction are performed interactively, the credibility and security of the off-chain transaction are also ensured, and erroneous transactions caused by human errors are avoided.

In addition, due to the use of digital currency for transactions, it is more conducive to building an interactive system for on-chain transactions and off-chain transactions. Meanwhile, in the absence of a network, digital currency transactions may be directly paid offline, lifting the restrictions for places with poor network signals.

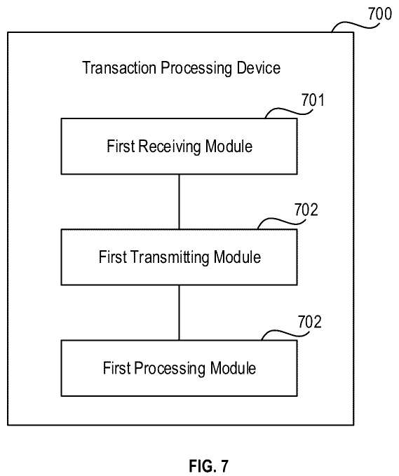

Based on similar technical concepts, embodiments of the disclosure provide a transaction processing device. As shown in FIG. 7, the device 700 includes: a first receiving module 701, configured to send a corresponding transaction pre-processing request to an off-chain payment system when receiving a transaction request sent by a blockchain, so that the off-chain payment system performs a corresponding transaction pre-processing operation, to obtain a transaction pre-processing outcome; a first transmitting module 702, configured to receive the transaction pre-processing outcome sent by the off-chain payment system, and send the transaction pre-processing outcome to the blockchain; and a first processing module 703, configured to send a transaction instruction note to the off-chain payment system when it is detected that the blockchain has generated an on-chain transaction outcome corresponding to the transaction request, where the transaction instruction note is used to instruct the off-chain payment system to perform a corresponding off-chain processing operation to obtain an off-chain transaction outcome corresponding to the transaction request, where the on-chain transaction outcome is obtained by the blockchain that performs an on-chain processing operation corresponding to the transaction request based on the transaction pre-processing outcome.

Optionally, the transaction request is sent by the blockchain by calling an oracle on a payment front-end device through a smart contract.

Optionally, the first receiving module 701 is specifically configured for: receiving an encrypted transaction request sent by the blockchain, where the transaction request is encrypted by the blockchain based on a public key of a payment front-end device; decrypting the encrypted transaction request to obtain transaction information in the transaction request; and generating the transaction pre-processing request based on the transaction information, and sending the transaction pre-processing request to the off-chain payment system.

Optionally, the first receiving module 701 is specifically configured for: when receiving a transaction request sent by the blockchain, determining whether the on-chain transaction identifier, contract name, and call sequence number included in the transaction request are consistent with an on-chain transaction identifier, contract name, and call sequence number included in a historical transaction request; and if the on-chain transaction identifier, contract name, and call sequence number included in the transaction request are consistent with an on-chain transaction identifier, contract name, and call sequence number included in a historical transaction request, sending the corresponding transaction pre-processing request to the off-chain payment system.

Optionally, the first receiving module 701 is further configured for: if the on-chain transaction identifier, contract name, and call sequence number included in the transaction request are consistent with an on-chain transaction identifier, contract name, and call sequence number included in a historical transaction request, determining whether a transaction pre-processing outcome corresponding to the transaction request has been cached; if the transaction pre-processing outcome corresponding to the transaction request has been cached, sending the cached transaction pre-processing outcome corresponding to the transaction request to the blockchain; and if the transaction pre-processing outcome corresponding to the transaction request has not been cached, waiting for the off-chain payment system to return the transaction pre-processing outcome corresponding to the transaction request.

Optionally, the first processing module 703 is further configured for: when it is detected that the blockchain has generated a predefined number of blocks corresponding to the transaction request, determining that the on-chain transaction outcome corresponding to the transaction request indicates a successful on-chain transaction; and if it is not detected that the blockchain has generated a predefined number of blocks corresponding to the transaction request, determining that the on-chain transaction outcome corresponding to the transaction request indicates an unsuccessful on-chain transaction, where the predefined number is determined based on configuration information of a consensus algorithm or endorsement strategy in the blockchain.

Optionally, the transaction request includes at least a sender account and a payment amount, and the transaction pre-processing request includes a request to lock the payment amount in the sender account; and the first processing module 703 is specifically configured for: when it is detected that the on-chain transaction outcome indicates a successful on-chain transaction, sending a first transaction instruction note to the off-chain payment system, where the first transaction instruction note is used to instruct the off-chain payment system to control the sender account to transfer the payment amount to a recipient account in the transaction request, to obtain a first off-chain transaction outcome.

Optionally, the first processing module 703 is further configured for: when it is detected that the on-chain transaction outcome indicates an unsuccessful on-chain transaction, sending a second transaction instruction to the off-chain payment system, where the second transaction instruction note is used to instruct the off-chain payment system to release the payment amount in the sender account, to obtain a second off-chain transaction outcome.

Optionally, the transaction request includes at least a sender account, a payment amount, and a recipient account, and the transaction pre-processing request includes controlling the sender account to transfer the payment amount to the recipient account and locking the payment amount in the recipient account; and the first processing module 703 is specifically configured for: when it is detected that the on-chain transaction outcome indicates a successful on-chain transaction, sending a third transaction instruction note to the off-chain payment system, where the third transaction instruction note is used to instruct the off-chain payment system to release the payment amount in the recipient account, to obtain a third off-chain transaction outcome.

Optionally, the first processing module 703 is further configured for: when it is detected that the on-chain transaction outcome indicates an unsuccessful on-chain transaction, sending a fourth transaction instruction note to the off-chain payment system, where the fourth transaction instruction note is used to instruct the off-chain payment system to control the recipient account to return the payment amount to the sender account, to obtain a fourth off-chain transaction outcome.

Optionally, the sender account is a payment token applied by a client terminal from a token service provider through a payment front-end device.

Optionally, the transaction request includes a sender address, a digital currency string corresponding to the sender address, and a recipient address, where the sender address and the recipient address are obtained by a client terminal through a digital currency wallet, and the transaction pre-processing request includes a request to lock the digital currency string; and the first processing module 703 is specifically configured for: when it is detected that the on-chain transaction outcome indicates a successful on-chain transaction, sending a fifth transaction instruction note to the off-chain payment system, where the fifth transaction instruction note is used to instruct the off-chain payment system to control a transfer of the digital currency string from the sender address to the recipient address, to obtain a fifth off-chain transaction outcome.

Optionally, the first processing module 703 is further configured for: when it is detected that the on-chain transaction outcome indicates an unsuccessful on-chain transaction, sending a sixth transaction instruction note to the off-chain payment system, where the sixth transaction instruction note is used to instruct the off-chain payment system to release the digital currency string, to obtain a sixth off-chain transaction outcome.

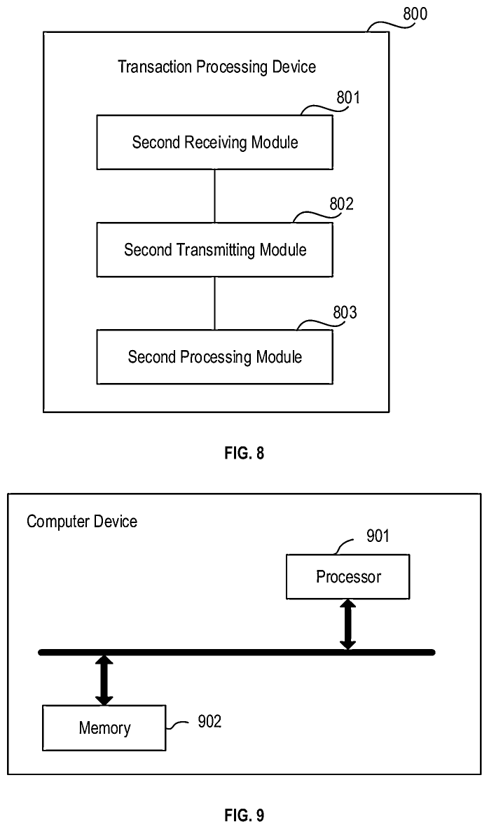

Based on similar technical concepts, embodiments of the disclosure provide a transaction processing device. As shown in FIG. 8, the device 800 includes: a second receiving module 801, configured to receive a transaction pre-processing request sent by a payment front-end device and perform a corresponding transaction pre-processing operation, to obtain a transaction pre-processing outcome, where the transaction pre-processing request is sent by the payment front-end device to an off-chain payment system after receiving a transaction request sent by a blockchain; a second transmitting module 802, configured to send the transaction pre-processing outcome to the payment front-end device to allow the payment front-end device to send the transaction pre-processing outcome to the blockchain; and a second processing module 803, configured to receive a transaction instruction note sent by the payment front-end device and perform a corresponding off-chain processing operation to obtain an off-chain transaction outcome corresponding to the transaction request, where the transaction instruction note is sent by the payment front-end device to the off-chain payment system when it is detected that the blockchain has generated an on-chain transaction outcome corresponding to the transaction request, where the on-chain transaction outcome is obtained by the blockchain that performs an on-chain processing operation corresponding to the transaction request based on the transaction pre-processing outcome.

Optionally, the transaction request includes at least a sender account and a payment amount, and the transaction pre-processing request includes a request to lock the payment amount in the sender account; and the second receiving module 801 is specifically configured for: receiving the transaction pre-processing request sent by the payment front-end device and locking the payment amount in the sender account.

Optionally, the second processing module 803 is specifically configured for: receiving a first transaction instruction note sent by the payment front-end device, and controlling the sender account to transfer the payment amount to a recipient account in the transaction request, to obtain a first off-chain transaction outcome; or receiving a second transaction instruction note sent by the payment front-end device, and releasing the payment amount in the sender account, to obtain a second off-chain transaction outcome.

Optionally, the transaction request includes at least a sender account, a payment amount, and a recipient account, and the transaction pre-processing request includes controlling the sender account to transfer the payment amount money to the recipient account and locking the payment amount in the recipient account; and the second receiving module 801 is specifically configured for: receiving the transaction pre-processing request sent by the payment front-end device, controlling the sender account to transfer the payment amount to the recipient account and locking the payment amount in the recipient account.

Optionally, the second processing module 803 is specifically configured for: receiving a third transaction instruction note sent by the payment front-end device, and releasing the payment amount in the recipient account, to obtain a third off-chain transaction outcome; or receiving a fourth transaction instruction note sent by the payment front-end device, controlling the recipient account to return the payment amount to the sender account, to obtain a fourth off-chain transaction outcome.

Optionally, the transaction request includes a sender address, a digital currency string corresponding to the sender address, and a recipient address, where the sender address and the recipient address are obtained by a client terminal through a digital currency wallet, and the transaction pre-processing request includes a request to lock the digital currency string; and the second receiving module 801 is specifically configured for: receiving the transaction pre-processing request sent by the payment front-end device and locking the digital currency string.

Optionally, the second processing module 803 is specifically configured for: receiving a fifth transaction instruction note sent by the payment front-end device, and controlling a transfer of the digital currency string from the sender address to the recipient address, to obtain a fifth off-chain transaction outcome; or receiving a sixth transaction instruction note sent by the payment front-end device, releasing the digital currency string, to obtain a sixth off-chain transaction outcome.

Based on similar technological concepts, embodiments of the disclosure provide a computer device, which can be a terminal or server. As shown in FIG. 9, the computer device includes at least one processor 901 and a memory 902 coupled to the at least one processor. The specific connection medium between the processor 901 and the memory 902 is not limited in the embodiments of the disclosure. In the example in FIG. 9, the connection between the processor 901 and the memory 902 is illustrated as a bus connection. The bus can be a kind of address bus, data bus, control bus, etc.

In the embodiments of the disclosure, the memory 902 stores instructions that can be executed by the at least one processor 901. By executing the instructions stored in the memory 902, the at least one processor 901 can perform the steps included in the transaction processing methods described above.

The at least one processor 901 serves as the control center of the computer device, connecting various parts of the computer device through various interfaces and lines. By running or executing the instructions stored in the memory 902 and calling the data stored in the memory 902, the at least one processor 901 can perform transaction processing. Optionally, the processor 901 may include one or more processing units, and the processor 901 may integrate application processors and modem processors. The application processor mainly handles the operating system, user interface, and applications, while the modem processor mainly handles wireless communication. It is understood that the modem processor mentioned above may also be not integrated into the processor 901. In some embodiments, the processor 901 and the memory 902 can be implemented on the same chip, and in some embodiments, the two can be implemented on separate chips.

Processor 901 can be a general-purpose processor, such as a central processing unit (CPU), digital signal processor, Application Specific Integrated Circuit (ASIC), field-programmable gate array, or other programmable logic devices, discrete gates or transistor logic devices, discrete hardware components, capable of implementing or executing the various methods, steps, and logic diagrams disclosed in the embodiments of the disclosure. A general-purpose processor can be a microprocessor or any conventional processor. The steps of the methods disclosed in the embodiments of the disclosure can be directly implemented by hardware processors or executed by a combination of hardware and software modules within the processors.

Memory 902, as a non-volatile computer-readable storage medium, can be configured to store non-volatile software programs and non-volatile computer-executable programs and modules. Memory 902 may include at least one type of storage medium, such as flash memory, hard disk, multimedia card, card-type storage, Random Access Memory (RAM), Static Random Access Memory (SRAM), Programmable Read Only Memory (PROM), Read-Only Memory (ROM), Electrically Erasable Programmable Read-Only Memory (EEPROM), magnetic storage, disk, optical disk, and the like. Memory 902 is any medium capable of implementing functions including, but not limited to, carrying or storing desired program codes in the form of instructions or data structures and can be accessed by a computer. In the embodiments of the disclosure, memory 902 may also be a circuit or any other device capable of implementing storage functions for storing program instructions and/or data.

Based on similar inventive concepts, the embodiments of the disclosure provide a computer-readable storage medium storing computer programs that can be executed by a computer device. When the programs run on a computer device, the computer device performs the steps of the transaction processing methods disclosed above.

Based on similar inventive concepts, the embodiments of the disclosure provide a computer program product, where the computer program product includes a computer program stored on a computer-readable storage medium. The computer program includes program instructions that, when executed by a computer, cause the computer to perform the steps of the transaction processing methods described above.

1. A transaction processing method, comprising:
when receiving a transaction request sent by a blockchain, sending a corresponding transaction pre-processing request to an off-chain payment system, so that the off-chain payment system performs a corresponding transaction pre-processing operation, to obtain a transaction pre-processing outcome;
receiving the transaction pre-processing outcome sent by the off-chain payment system, and sending the transaction pre-processing outcome to the blockchain; and
when it is detected that the blockchain has generated an on-chain transaction outcome corresponding to the transaction request, sending a transaction instruction note to the off-chain payment system, wherein the transaction instruction note is used to instruct the off-chain payment system to perform a corresponding off-chain processing operation to obtain an off-chain transaction outcome corresponding to the transaction request, wherein the on-chain transaction outcome is obtained by the blockchain that performs an on-chain processing operation corresponding to the transaction request based on the transaction pre-processing outcome.

2. The method according to claim 1, wherein the transaction request is sent by the blockchain by calling an oracle on a payment front-end device through a smart contract.

3. The method according to claim 1, wherein when receiving a transaction request sent by a blockchain, sending a corresponding transaction pre-processing request to an off-chain payment system comprises:
receiving an encrypted transaction request sent by the blockchain, wherein the transaction request is encrypted by the blockchain based on a public key of a payment front-end device;
decrypting the encrypted transaction request to obtain transaction information in the transaction request; and
generating the transaction pre-processing request based on the transaction information, and sending the transaction pre-processing request to the off-chain payment system.

4. The method according to claim 1, wherein when receiving a transaction request sent by a blockchain, sending a corresponding transaction pre-processing request to an off-chain payment system comprises:
when receiving a transaction request sent by the blockchain, determining whether the on-chain transaction identifier, contract name, and call sequence number included in the transaction request are consistent with an on-chain transaction identifier, contract name, and call sequence number included in a historical transaction request; and
if the on-chain transaction identifier, contract name, and call sequence number included in the transaction request are consistent with an on-chain transaction identifier, contract name, and call sequence number included in a historical transaction request, sending the corresponding transaction pre-processing request to the off-chain payment system.

5. The method according to claim 4, further comprising:
if the on-chain transaction identifier, contract name, and call sequence number included in the transaction request are consistent with an on-chain transaction identifier, contract name, and call sequence number included in a historical transaction request, determining whether a transaction pre-processing outcome corresponding to the transaction request has been cached;
if the transaction pre-processing outcome corresponding to the transaction request has been cached, sending the cached transaction pre-processing outcome corresponding to the transaction request to the blockchain; and
if the transaction pre-processing outcome corresponding to the transaction request has not been cached, waiting for the off-chain payment system to return the transaction pre-processing outcome corresponding to the transaction request.

6. The method according to claim 1, wherein, before sending the transaction instruction note to the off-chain payment system, the method further comprises:
when it is detected that the blockchain has generated a predefined number of blocks corresponding to the transaction request, determining that the on-chain transaction outcome corresponding to the transaction request indicates a successful on-chain transaction; and
if it is not detected that the blockchain has generated a predefined number of blocks corresponding to the transaction request, determining that the on-chain transaction outcome corresponding to the transaction request indicates an unsuccessful on-chain transaction, wherein the predefined number is determined based on configuration information of a consensus algorithm or endorsement strategy in the blockchain.

7. The method according to claim 6, wherein the transaction request includes at least a sender account and a payment amount, and the transaction pre-processing request includes a request to lock the payment amount in the sender account; and
wherein, when it is detected that the blockchain has generated an on-chain transaction outcome corresponding to the transaction request, sending a transaction instruction note to the off-chain payment system, wherein the transaction instruction note is used to instruct the off-chain payment system to perform a corresponding off-chain processing operation to obtain an off-chain transaction outcome corresponding to the transaction request, comprises:
when it is detected that the on-chain transaction outcome indicates a successful on-chain transaction, sending a first transaction instruction note to the off-chain payment system, wherein the first transaction instruction note is used to instruct the off-chain payment system to control the sender account to transfer the payment amount to a recipient account in the transaction request, to obtain a first off-chain transaction outcome.

8. The method according to claim 7, further comprising:
when it is detected that the on-chain transaction outcome indicates an unsuccessful on-chain transaction, sending a second transaction instruction to the off-chain payment system, wherein the second transaction instruction note is used to instruct the off-chain payment system to release the payment amount in the sender account, to obtain a second off-chain transaction outcome.

9. The method according to claim 6, wherein the transaction request includes at least a sender account, a payment amount, and a recipient account, and the transaction pre-processing request includes controlling the sender account to transfer the payment amount to the recipient account and locking the payment amount in the recipient account; and
wherein, when it is detected that the blockchain has generated an on-chain transaction outcome corresponding to the transaction request, sending a transaction instruction note to the off-chain payment system, wherein the transaction instruction note is used to instruct the off-chain payment system to perform a corresponding off-chain processing operation to obtain an off-chain transaction outcome corresponding to the transaction request, comprises:
when it is detected that the on-chain transaction outcome indicates a successful on-chain transaction, sending a third transaction instruction note to the off-chain payment system, wherein the third transaction instruction note is used to instruct the off-chain payment system to release the payment amount in the recipient account, to obtain a third off-chain transaction outcome.

10. The method according to claim 9, further comprising:
when it is detected that the on-chain transaction outcome indicates an unsuccessful on-chain transaction, sending a fourth transaction instruction note to the off-chain payment system, wherein the fourth transaction instruction note is used to instruct the off-chain payment system to control the recipient account to return the payment amount to the sender account, to obtain a fourth off-chain transaction outcome.

11. The method according to claim 7, wherein the sender account is a payment token applied by a client terminal from a token service provider through a payment front-end device.

12. The method according to claim 1, wherein the transaction request includes a sender address, a digital currency string corresponding to the sender address, and a recipient address, wherein the sender address and the recipient address are obtained by a client terminal through a digital currency wallet, and the transaction pre-processing request includes a request to lock the digital currency string; and
wherein, when it is detected that the blockchain has generated an on-chain transaction outcome corresponding to the transaction request, sending a transaction instruction note to the off-chain payment system, wherein the transaction instruction note is used to instruct the off-chain payment system to perform a corresponding off-chain processing operation to obtain an off-chain transaction outcome corresponding to the transaction request, comprises:
when it is detected that the on-chain transaction outcome indicates a successful on-chain transaction, sending a fifth transaction instruction note to the off-chain payment system, where the fifth transaction instruction note is used to instruct the off-chain payment system to control a transfer of the digital currency string from the sender address to the recipient address, to obtain a fifth off-chain transaction outcome.

13. The method according to claim 12, further comprising:
when it is detected that the on-chain transaction outcome indicates an unsuccessful on-chain transaction, sending a sixth transaction instruction note to the off-chain payment system, wherein the sixth transaction instruction note is used to instruct the off-chain payment system to release the digital currency string, to obtain a sixth off-chain transaction outcome.

14. A transaction processing method, comprising:
receiving a transaction pre-processing request sent by a payment front-end device and performing a corresponding transaction pre-processing operation, to obtain a transaction pre-processing outcome, wherein the transaction pre-processing request is sent by the payment front-end device to an off-chain payment system after receiving a transaction request sent by a blockchain;
sending the transaction pre-processing outcome to the payment front-end device to allow the payment front-end device to send the transaction pre-processing outcome to the blockchain; and
receiving a transaction instruction note sent by the payment front-end device and performing a corresponding off-chain processing operation to obtain an off-chain transaction outcome corresponding to the transaction request, wherein the transaction instruction note is sent by the payment front-end device to the off-chain payment system when it is detected that the blockchain has generated an on-chain transaction outcome corresponding to the transaction request, wherein the on-chain transaction outcome is obtained by the blockchain that performs an on-chain processing operation corresponding to the transaction request based on the transaction pre-processing outcome.

15. The method according to claim 14, wherein the transaction request includes at least a sender account and a payment amount, and the transaction pre-processing request includes a request to lock the payment amount in the sender account; and
wherein receiving a transaction pre-processing request sent by a payment front-end device and performing a corresponding transaction pre-processing operation, to obtain a transaction pre-processing outcome comprises:
receiving the transaction pre-processing request sent by the payment front-end device and locking the payment amount in the sender account.

16. The method according to claim 15, wherein receiving a transaction instruction note sent by the payment front-end device and performing a corresponding off-chain processing operation to obtain an off-chain transaction outcome corresponding to the transaction request comprises:
receiving a first transaction instruction note sent by the payment front-end device, and controlling the sender account to transfer the payment amount to a recipient account in the transaction request, to obtain a first off-chain transaction outcome; or
receiving a second transaction instruction note sent by the payment front-end device, and releasing the payment amount in the sender account, to obtain a second off-chain transaction outcome.

17. The method according to claim 14, wherein the transaction request includes at least a sender account, a payment amount, and a recipient account, and the transaction pre-processing request includes controlling the sender account to transfer the payment amount money to the recipient account and locking the payment amount in the recipient account; and
wherein receiving a transaction pre-processing request sent by a payment front-end device and performing a corresponding transaction pre-processing operation, to obtain a transaction pre-processing outcome comprises:
receiving the transaction pre-processing request sent by the payment front-end device, controlling the sender account to transfer the payment amount to the recipient account and locking the payment amount in the recipient account.

18. The method according to claim 17, wherein receiving a transaction instruction note sent by the payment front-end device and performing a corresponding off-chain processing operation to obtain an off-chain transaction outcome corresponding to the transaction request comprises:
receiving a third transaction instruction note sent by the payment front-end device, and releasing the payment amount in the recipient account, to obtain a third off-chain transaction outcome; or
receiving a fourth transaction instruction note sent by the payment front-end device, controlling the recipient account to return the payment amount to the sender account, to obtain a fourth off-chain transaction outcome.

19. (canceled)

20. (canceled)

21. (canceled)

22. (canceled)

23. A computer device, comprising a memory, a processor, and a computer program stored in the memory and executable on the processor, wherein the processor, when executing the program, implements the method according to claim 1.

24. A computer-readable storage medium, storing a computer program executable on a computer device, wherein the computer program, when executed on the computer device, causes the computer device to implement the method according to claim 1.

25. (canceled)
